(19) United States
(12) Patent Application Publication
(10) Pub. No.: US 2026/0302997 A1
(43) Pub. Date: Oct. 1, 2026

(54) SYSTEMS AND METHODS FOR AUTOMATICALLY SWITCHING BETWEEN SEVEN-PHASE SPACE VECTOR PULSE WIDTH MODULATION AND FIVE-PHASE SPACE VECTOR PULSE WIDTH MODULATION

(71) Applicant: STEERING SOLUTIONS IP HOLDING CORPORATION, Saginaw, MI (US)

(72) Inventors: Taibin WANG, Suzhou (CN); Snowy ZHANG, Suzhou (CN); Weiwei PENG, Suzhou (CN); Meng ZHOU, Suzhou (CN)

(21) Appl. No.: 19/199,896

(22) Filed: May 6, 2025

(30) Foreign Application Priority Data
Mar. 26, 2025 (CN) 202510369925.1

(51) Int. Cl. H02P 27/12; H02P 21/18; H02P 21/22

(52) U.S. Cl. CPC H02P 27/12; H02P 21/18; H02P 21/22

(57) ABSTRACT

A method for motor control includes receiving a plurality of data points associated with operation of a motor, determining a phase angle of the motor, and retrieving, from a lookup table, a seven-phase pulse width modulation equation based on the phase angle of the motor. The method also includes determining a result of the seven-phase pulse width modulation equation, receiving a modulation index value; and, in response to the modulation index value being less than or equal to a first threshold value, selectively controlling the motor based on the result of the seven-phase pulse width modulation equation.

### CROSS REFERENCE TO RELATED APPLICATIONS

This U.S. Non-Provisional Patent Application claims the benefit of and priority to Chinese Patent Application Serial No. 202510369925.1, filed Mar. 26, 2025, the contents of which are incorporated herein by reference in its entirety.

### TECHNICAL FIELD

This disclosure relates to steering systems, and in particular, to systems and methods for controlling aspects of a steering system by automatically switching between seven-phase space vector pulse width modulation and five-phase space vector pulse width modulation using a lookup table.

### BACKGROUND

A vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

### SUMMARY

This disclosure relates generally to steering systems.

An aspect of the disclosed embodiments includes a system for motor control. The system includes a processor, and a memory. The memory includes instructions that, when executed by the processor, cause the processor to: receive a plurality of data points associated with operation of a motor; determine a phase angle of the motor; retrieve, from a lookup table, a seven-phase pulse width modulation equation based on the phase angle of the motor; determine a result of the seven-phase pulse width modulation equation; receive a modulation index value; and in response to the modulation index value being less than or equal to a first threshold value, selectively control the motor based on the result of the seven-phase pulse width modulation equation.

Another aspect of the disclosed embodiments includes a method for motor control. The method includes receiving a plurality of data points associated with operation of a motor, determining a phase angle of the motor, and retrieving, from a lookup table, a seven-phase pulse width modulation equation based on the phase angle of the motor. The method also includes determining a result of the seven-phase pulse width modulation equation, receiving a modulation index value; and, in response to the modulation index value being less than or equal to a first threshold value, selectively controlling the motor based on the result of the seven-phase pulse width modulation equation.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a controller according to the principles of the present disclosure.

FIG. 3A generally illustrates various aspects of five-phase space vector pulse width modulation and seven-phase space vector pulse width modulation according to the principles of the present disclosure.

FIG. 3B generally illustrates a space vector pulse width modulation flow chart according to the principles of the present disclosure.

FIGS. 4A-4C generally illustrate various aspects of five-phase space vector pulse width modulation according to the principles of the present disclosure.

FIGS. 5A-5C generally illustrate various aspects of five-phase space vector pulse width modulation according to the principles of the present disclosure.

FIGS. 6A and 6B generally illustrate various aspects of seven-phase space vector pulse width modulation according to the principles of the present disclosure.

FIGS. 7A and 7B generally illustrate various aspects of seven-phase space vector pulse width modulation according to the principles of the present disclosure.

FIG. 8 generally illustrates a space vector pulse width modulation lookup table according to the principles of the present disclosure.

FIG. 9 is a flow diagram generally illustrating a motor control method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an EPS system, an SbW steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

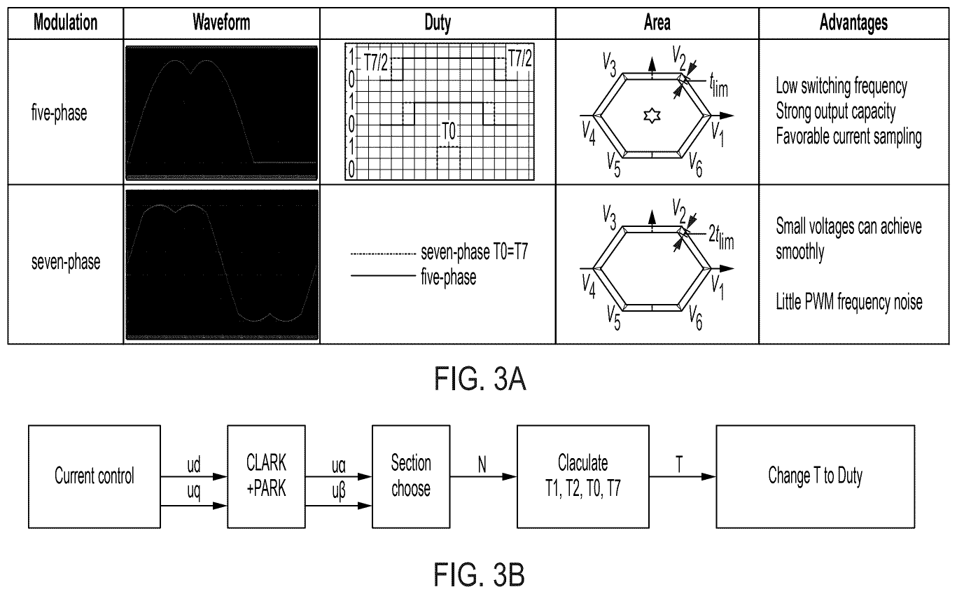

Controlling such various aspects of the vehicle steering and/or any other suitable aspect of the vehicle, includes using and/or controlling various motors. This may including controlling a duty cycle of a motor and/or adjusting various pulse width modulation aspects. For example, it may be common to use five-phase space vector pulse width modulation (SVPWM) and/or seven-phase SVPWM, which each have advantages and disadvantages, as is generally illustrated in FIGS. 3A and 3B. Typically, the two methods are combined to make use of the advantages of each. However, this may be relatively calculation and/or resource intensive.

Accordingly, systems and methods, such as those described herein, configured to provide an improved approach to combining seven-phase SPPWM and five-phase SVPWM, may be desirable. In some embodiments the systems and methods described herein may be configured to use a look table way to realize seven-phase SVPWM and combine a five-phase SVPM look table to combine the seven-phase SPPWM and the five-phase SVPWM. The systems and methods described herein may be configured to switch lookup tables to achieve the SVPWM.

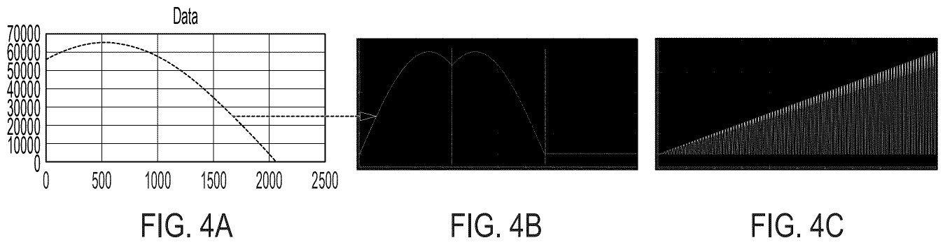

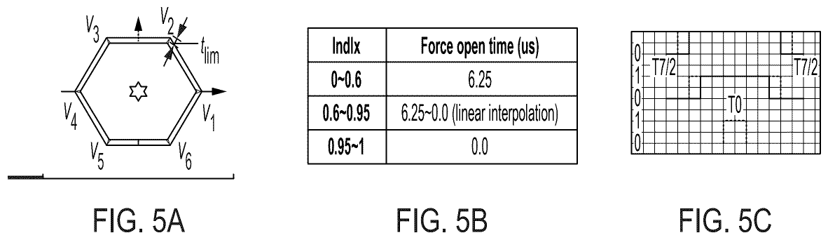

In some embodiments, the systems and methods described herein may be configured to realize the five-phase SVPWM by retrieving a value from a lookup table, and to optimize relatively small voltages based on a force open time (e.g., because of time T0 is not equal to time T7, the PWM noise is larger). As is illustrated in FIG. 4A, the systems and methods described herein may be configured to extract data from 120 degrees to ~240 degrees and restore one period (e.g., FIG. 4B) using the lookup table. The systems and methods described herein may be configured to follow different index (e.g., FIG. 4C). FIGS. 5A-5C generally illustrate small voltage optimization.

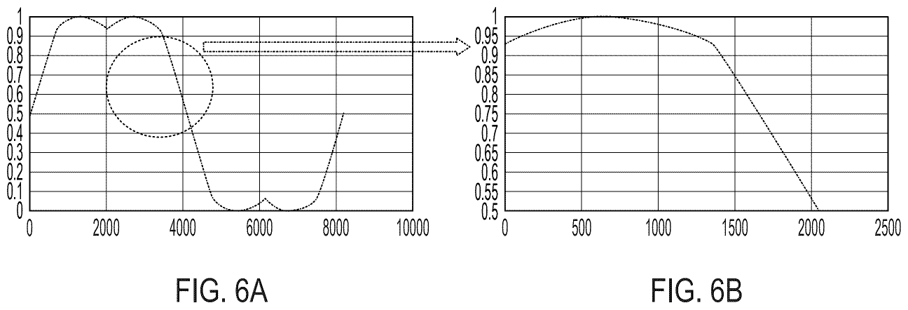

In some embodiments, the systems and methods described herein may be configured to, for seven-phase SVPWM retrieve a period of data which include 8192 points, as is generally illustrated in FIGS. 6A and 6B. The systems and methods described herein may be configured to extract 1/4 for the lookup table.

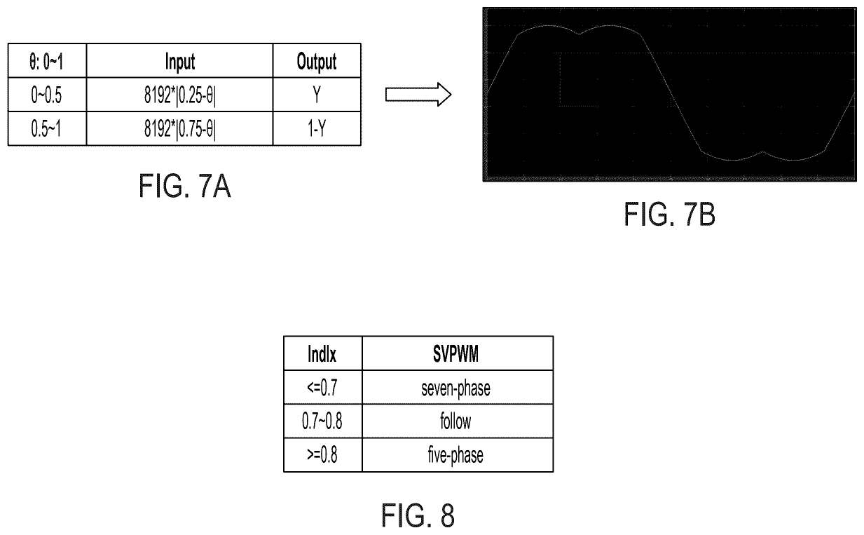

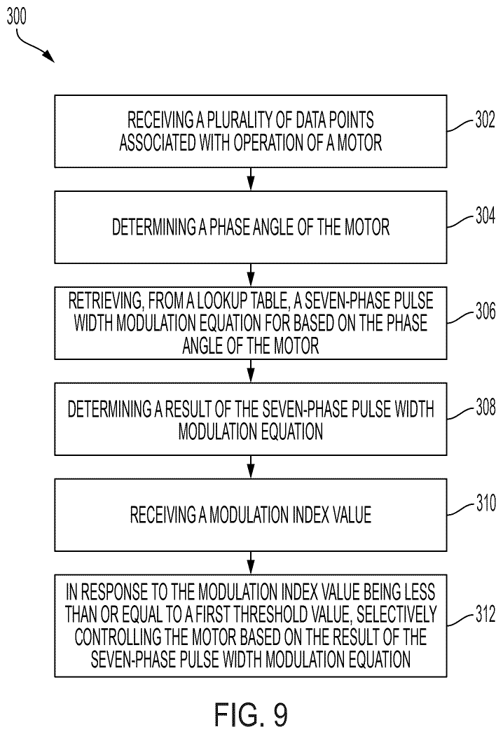

The systems and methods described herein may be configured to use a rotor angle of a motor (e.g., such as a motor associated with a steering system, such as those described herein) for input to the lookup table. The systems and methods described herein may be configured to follow the logic in lookup table to arrive at the output as the duty cycle, when the index is 1 (e.g., as is generally illustrated in FIGS. 7A and 7B).

The systems and methods described herein may be configured to, in order to meet various index values, use the following equation:

$$Modln IdxPha = {( 0.5 - Z )}^{*} Indix + 0.5$$

As is generally illustrated in FIG. 8, the systems and methods described herein may be configured to combine five-phase and seven-phase SVPWM using hysteresis control to avoid frequent switching.

In some embodiments, the systems and methods described herein may be configured to receive a plurality of data points associated with operation of a motor. The plurality of data points may correspond to one operational period of the motor. The plurality of data points may include 8192 data points, or other suitable number of data points. The motor may include any suitable motor and may be associated with a steering system or other suitable aspect of the vehicle.

The systems and methods described herein may be configured to determine a phase angle of the motor. The systems and methods described herein may be configured to retrieve, from a lookup table, a seven-phase pulse width modulation equation based on the phase angle of the motor. The seven-phase pulse width modulation equation may include a seven-phase space vector pulse width modulation equation. In some embodiments, in response to the phase angle of the motor being between 0 and 0.5, the seven-phase pulse width modulation equation includes a first equation. The first equation may include a total number of data points of the plurality of data points times an absolute value of a predetermined value minus the phase angle of the motor. In some embodiments, in response to the phase angle of the motor being between 0.5 and 1, the seven-phase pulse width modulation equation includes a second equation. The second equation may include a total number of data points of the plurality of data points times an absolute value of 1 minus a predetermined value minus the phase angle of the motor.

The systems and methods described herein may be configured to determine a result of the seven-phase pulse width modulation equation. The systems and methods described herein may be configured to receive a modulation index value. The systems and methods described herein may be configured to, in response to the modulation index value being less than or equal to a first threshold value, selectively control the motor based on the result of the seven-phase pulse width modulation equation. The first threshold may equal 0.7.

In some embodiments, the systems and methods described herein may be configured to, in response to the modulation index value being greater than or equal to a second threshold value, selectively control the motor based on an identified duty cycle associated with five-phase pulse width modulation. The second threshold may equal 0.8. The five-phase pulse width modulation may include a five-phase space vector pulse width modulation.

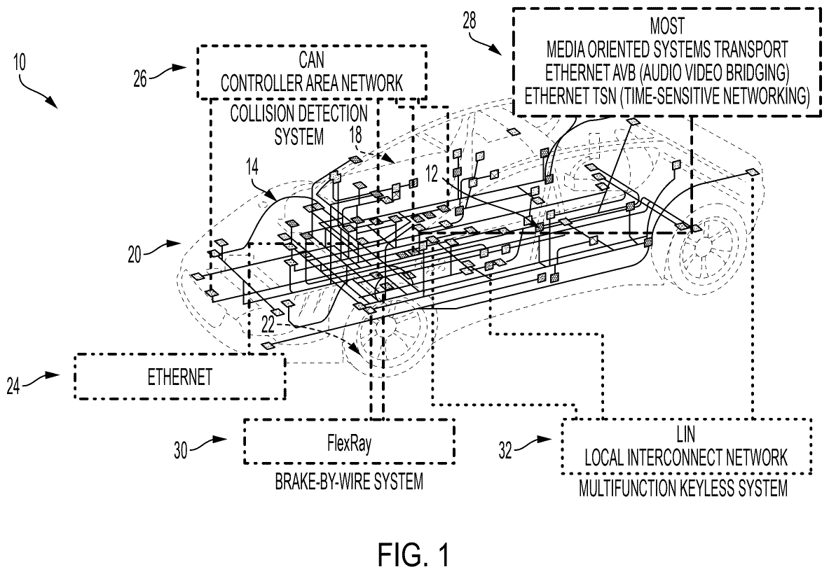

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

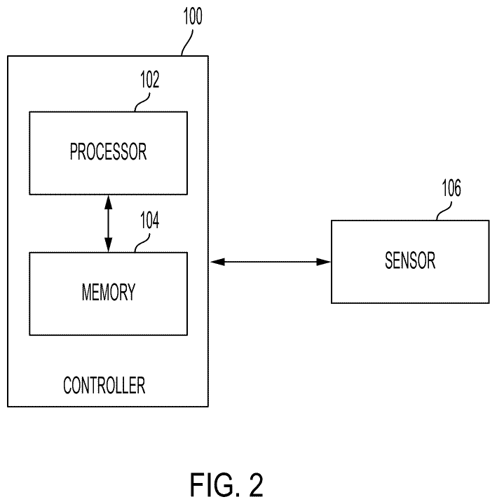

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, one or more radar sensors or devices, one or more lidar sensors or devices, one or more sonar sensors or devices, one or more image capturing sensors or devices, other suitable sensors or devices, or a combination thereof. The one or more signals may indicate a handwheel torque, a handwheel angle, a motor velocity, a vehicle speed, other suitable information, or a combination thereof.

In some embodiments, the controller 100 may be configured to receive a plurality of data points associated with operation of a motor. The plurality of data points may correspond to one operational period of the motor. The plurality of data points may include 8192 data points, or other suitable number of data points. The motor may include any suitable motor and may be associated with a steering system or other suitable aspect of the vehicle.

The controller 100 may determine a phase angle of the motor. The controller 100 may retrieve, from a lookup table (e.g., which may be stored in the memory 104 or any other suitable memory, and/or may be stored on a remote computing device in communication with the controller 100 and/or the vehicle 10), a seven-phase pulse width modulation equation based on the phase angle of the motor. The seven-phase pulse width modulation equation may include a seven-phase space vector pulse width modulation equation. In some embodiments, in response to the phase angle of the motor being between 0 and 0.5, the seven-phase pulse width modulation equation includes a first equation. The first equation may include a total number of data points of the plurality of data points times an absolute value of a predetermined value minus the phase angle of the motor. In some embodiments, in response to the phase angle of the motor being between 0.5 and 1, the seven-phase pulse width modulation equation includes a second equation. The second equation may include a total number of data points of the plurality of data points times an absolute value of 1 minus a predetermined value minus the phase angle of the motor.

The controller 100 may determine a result of the seven-phase pulse width modulation equation. The controller 100 may receive a modulation index value. The controller 100 may, in response to the modulation index value being less than or equal to a first threshold value, selectively control the motor based on the result of the seven-phase pulse width modulation equation. The first threshold may equal 0.7.

In some embodiments, the controller 100 may, in response to the modulation index value being greater than or equal to a second threshold value, selectively control the motor based on an identified duty cycle associated with five-phase pulse width modulation. The second threshold may equal 0.8. The five-phase pulse width modulation may include a five-phase space vector pulse width modulation.

In some embodiments, the controller 100 may perform the methods described herein. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

FIG. 4 is a flow diagram generally illustrated a motor control method 300 according to the principles of the present disclosure. At 302, the method 300 receives a plurality of data points associated with operation of a motor.
At 304, the method 300 determines a phase angle of the motor.
At 306, the method 300 retrieves, from a lookup table, a seven-phase pulse width modulation equation based on the phase angle of the motor.
At 308, the method 300 determines a result of the seven-phase pulse width modulation equation.
At 310, the method 300 receives a modulation index value.
At 312, the method 300, in response to the modulation index value being less than or equal to a first threshold value, selectively controls the motor based on the result of the seven-phase pulse width modulation equation.

In some embodiments, a system for motor control includes a processor, and a memory. The memory includes instructions that, when executed by the processor, cause the processor to: receive a plurality of data points associated with operation of a motor; determine a phase angle of the motor; retrieve, from a lookup table, a seven-phase pulse width modulation equation based on the phase angle of the motor; determine a result of the seven-phase pulse width modulation equation; receive a modulation index value; and in response to the modulation index value being less than or equal to a first threshold value, selectively control the motor based on the result of the seven-phase pulse width modulation equation.

In some embodiments, the plurality of data points corresponds to one operational period of the motor. In some embodiments, the plurality of data points includes 8192 data points. In some embodiments, the seven-phase pulse width modulation equation includes a seven-phase space vector pulse width modulation equation. In some embodiments, in response to the phase angle of the motor being between 0 and 0.5, the seven-phase pulse width modulation equation includes a first equation. In some embodiments, the first equation includes a total number of data points of the plurality of data points times an absolute value of a predetermined value minus the phase angle of the motor. In some embodiments, in response to the phase angle of the motor being between 0.5 and 1, the seven-phase pulse width modulation equation includes a second equation. In some embodiments, the second equation includes a total number of data points of the plurality of data points times an absolute value of 1 minus a predetermined value minus the phase angle of the motor. In some embodiments, the result is a duty cycle value. In some embodiments, the first threshold equals 0.7. In some embodiments, the instructions further cause the processor to, in response to the modulation index value being greater than or equal to a second threshold value, selectively control the motor based on an identified duty cycle associated with five-phase pulse width modulation. In some embodiments, the second threshold equals 0.8. In some embodiments, the five-phase pulse width modulation includes a five-phase space vector pulse width modulation.

In some embodiments, a method for motor control includes receiving a plurality of data points associated with operation of a motor, determining a phase angle of the motor, and retrieving, from a lookup table, a seven-phase pulse width modulation equation based on the phase angle of the motor. The method also includes determining a result of the seven-phase pulse width modulation equation, receiving a modulation index value; and, in response to the modulation index value being less than or equal to a first threshold value, selectively controlling the motor based on the result of the seven-phase pulse width modulation equation.

In some embodiments, the plurality of data points corresponds to one operational period of the motor. In some embodiments, the plurality of data points includes 8192 data points. In some embodiments, the seven-phase pulse width modulation equation includes a seven-phase space vector pulse width modulation equation. In some embodiments, the method also includes, in response to the modulation index value being greater than or equal to a second threshold value, selectively controlling the motor based on an identified duty cycle associated with five-phase pulse width modulation. In some embodiments, the second threshold is greater than the first threshold. In some embodiments, the five-phase pulse width modulation includes a five-phase space vector pulse width modulation.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A system for motor control, the system comprising:
a processor; and
a memory including instructions that, when executed by the processor, cause the processor to:
receive a plurality of data points associated with operation of a motor;
determine a phase angle of the motor;
retrieve, from a lookup table, a seven-phase pulse width modulation equation based on the phase angle of the motor;
determine a result of the seven-phase pulse width modulation equation;
receive a modulation index value; and
in response to the modulation index value being less than or equal to a first threshold value, selectively control the motor based on the result of the seven-phase pulse width modulation equation.

2. The system of claim 1, wherein the plurality of data points corresponds to one operational period of the motor.

3. The system of claim 1, wherein the plurality of data points includes 8192 data points.

4. The system of claim 1, wherein the seven-phase pulse width modulation equation includes a seven-phase space vector pulse width modulation equation.

5. The system of claim 1, wherein, in response to the phase angle of the motor being between 0 and 0.5, the seven-phase pulse width modulation equation includes a first equation.

6. The system of claim 5, wherein the first equation includes a total number of data points of the plurality of data points times an absolute value of a predetermined value minus the phase angle of the motor.

7. The system of claim 1, wherein, in response to the phase angle of the motor being between 0.5 and 1, the seven-phase pulse width modulation equation includes a second equation.

8. The system of claim 7, wherein the second equation includes a total number of data points of the plurality of data points times an absolute value of 1 minus a predetermined value minus the phase angle of the motor.

9. The system of claim 1, wherein the result is a duty cycle value.

10. The system of claim 1, wherein the first threshold equals 0.7.

11. The system of claim 1, wherein the instructions further cause the processor to, in response to the modulation index value being greater than or equal to a second threshold value, selectively control the motor based on an identified duty cycle associated with five-phase pulse width modulation.

12. The system of claim 11, wherein the second threshold equals 0.8.

13. The system of claim 11, wherein the five-phase pulse width modulation includes a five-phase space vector pulse width modulation.

14. A method for motor control, the method comprising:
receiving a plurality of data points associated with operation of a motor;
determining a phase angle of the motor;
retrieving, from a lookup table, a seven-phase pulse width modulation equation based on the phase angle of the motor;
determining a result of the seven-phase pulse width modulation equation;
receiving a modulation index value; and
in response to the modulation index value being less than or equal to a first threshold value, selectively controlling the motor based on the result of the seven-phase pulse width modulation equation.

15. The method of claim 14, wherein the plurality of data points corresponds to one operational period of the motor.

16. The method of claim 14, wherein the plurality of data points includes 8192 data points.

17. The method of claim 14, wherein the seven-phase pulse width modulation equation includes a seven-phase space vector pulse width modulation equation.

18. The method of claim 14, further comprising, in response to the modulation index value being greater than or equal to a second threshold value, selectively controlling the motor based on an identified duty cycle associated with five-phase pulse width modulation.

19. The method of claim 18, wherein the second threshold is greater than the first threshold.

20. The method of claim 18, wherein the five-phase pulse width modulation includes a five-phase space vector pulse width modulation.
